(19) United States
(12) Patent Application Publication
(10) Pub. No.: US 2024/0110064 A1
(43) Pub. Date: Apr. 4, 2024

(54) HIGH-COATING METAL EFFECT PIGMENTS

(71) Applicant: SCHLENK METALLIC PIGMENTS GMBH, Roth (DE)

(72) Inventors: Adalbert HUBER, Bensheim (DE); Matthias STÖTER, Altdorf bei Nurnberg (DE); Jörg SCHNEIDER, Seeheim-Jugenheim (DE); Rudolf HOFFMANN, Darmstadt (DE); Thorsten BIES, Darmstadt (DE)

(21) Appl. No.: 17/767,583

(22) PCT Filed: Apr. 13, 2021
(86) PCT No.: PCT/EP2021/059559

§ 371 Date: Apr. 8, 2022

(30) Foreign Application Priority Data
Apr. 27, 2020 (EP) 20171634.7

(51) Int. Cl. C09C 1/00; C09D 5/29; C09D 7/40; C09D 7/62

(52) U.S. Cl. CPC C09C 1/0021; C09D 5/29; C09D 7/62; C09D 7/70; C01P 2004/24; C01P 2004/80; C01P 2006/60; C08K 9/02; C09C 2200/1054; C09C 2200/301; C09C 2200/302; C09C 2220/103; C09C 2220/106

(57) ABSTRACT

The present invention relates to a method for producing metal effect pigments based on aluminum platelets which are provided with a metal oxide coating, said method comprising the following steps: (a) providing the aluminum platelets in an organic solvent so as to form a corresponding dispersion and adding at least one metal oxide precursor compound while the metal oxide precursor compound is dissolved, and b) decomposing the metal oxide precursor compound in the organic solvent so as to form the metal oxide coating on the aluminum platelets. The present invention further relates to metal effect pigments that can be obtained by the method according to the invention as well as to the use of the metal effect pigments according to the invention.

The present invention relates to a method for producing metallic effect pigments on the basis of aluminum flakes furnished with a metal oxide coating, to metallic effect pigments obtainable by the method of the invention, and the use of the metallic effect pigments of the invention.

Colored and light-stable metallic effect pigments are produced according to the prior art by coating thin, plateletlike substrates of metal, such as aluminum, with metal oxides, such as Fe₂O₃ and TiO₂, for example. In order to achieve high hiding power, the metallic effect pigments ought to have extremely low overall thickness. The thinner the metallic effect pigments, the higher their hiding power, since a greater area can be covered for a given mass of pigment deployed. For this reason, the substrates generally used are extremely thin metal platelets, or flakes. These thin metal flakes are themselves designated as pigments.

Substrates of this kind made of aluminum, i.e. aluminum pigments, are produced industrially in two different ways. Relatively thin aluminum flakes may be obtained, for example, by cost-effective, low-impact wet milling processes. In the course of the milling, metal beads give off rounded aluminum particles. Depending on the size of these particles, the duration of milling, and the metal beads employed, thin aluminum flakes are the result. With particularly low-impact milling processes it is possible on the industrial scale to attain median substrate thickness values in the range from 60 to 100 nm for relatively large flake diameters. As a result of the cold deformation during the milling, however, the aluminum flakes always have a certain thickness fluctuation and surface roughness—that is, the aluminum flakes are not perfectly planar. This thickness fluctuation and surface roughness have the advantage, conversely, that the resultant aluminum flakes are not in extensive contact during drying and can therefore be dried relatively easily without agglomeration. The non-agglomerative drying becomes increasingly difficult, however, as the substrate thickness reduces and the specific surface area goes up. Moreover, as the milling factor increases, i.e., on further giving-off of thin aluminum flakes, the production-related thickness fluctuations are a disadvantage. In general there are fissures and scattering frayed edges to the aluminum flakes, which form scattering centers and increasingly detract from the optical properties of the pigment. These frayed edges occur more and more particularly for pigments with a substantial diameter in the region of 20 μm or more. Accordingly, it is not possible to obtain arbitrarily thin aluminum flakes of high diameter by means of wet milling. EP 2 102 294 B1, for example, describes aluminum flakes obtained by wet milling and having a mean thickness of 32 nm, but for a d₅₀ of less than 10 μm. For aluminum flakes having a larger d₅₀, however, it has not been possible to demonstrate experimentally a mean thickness of this kind without the above-described fissures and scattering frayed edges. The d₅₀ here indicates the mean size of the aluminum flakes at which 50% of the aluminum flakes are smaller than the specified value.

In order to obtain even thinner aluminum flakes, a more complicated, costly and energy-intensive production method is employed. According to the prior art, even thinner aluminum flakes are produced industrially by physical vapor deposition (PVD for short). In this method, in general, a polymeric film is first coated with a detachable release coat and a nanometer-thin aluminum layer is applied by vacuum vapor deposition. The advantage of this method relative to the wet milling lies in the formation of extremely smooth, mirrorlike metal surfaces. The almost perfect metal layer can be detached from the film and then comminuted to give the desired flake. Aluminum flakes produced by PVD are therefore substantially thinner and smoother, as an inherent result of the process, than aluminum flakes obtained from the wet milling process. Because of the low thickness of the aluminum flakes produced by PVD it is possible, ultimately, to obtain metallic effect pigments whose hiding power is much higher than when using aluminum flakes from wet milling. Generally speaking, aluminum flakes produced by PVD have a thickness in the range from 5 to 50 nm. A disadvantage of the smooth surface, however, is the strong propensity to agglomerate. The areas of contact are very extensive, and so the agglomeration propensity on drying is significantly more pronounced than for aluminum flakes from wet milling. Aluminum flakes produced by PVD are occasionally also referred to as vacuum-metallized pigments (VMPs for short).

A colored and light-stable metallic effect pigment is typically obtained, as mentioned earlier, by coating with metal oxides. The furnishing of the substrates with coloring metal oxide coatings may be accomplished either in the gas phase, as for instance by chemical vapor deposition (CVD for short), or via precipitation in aqueous operations, as for instance by hydrolysis of the corresponding metal halides. The color of the pigments comes about through the interaction of absorption, transmission and interference, with thicknesses and refractive index of the metal oxide coating, in particular, determining the color of the metallic effect pigment.

The direct CVD coating leads merely to an oxide coating on only one side of the two aluminum surfaces. As a consequence of this, only one of the two aluminum surfaces has a color. In order to carry out coating on all sides uniformly with the metal oxide, fluidized bed methods have been developed, and are described for example in EP 0 033 457 A2, DE 42 23 384 A1 and EP 0 562 329 A1.

In these methods, commonly, a substrate is coated with iron oxide and optionally with further transparent oxides in a fluidized bed, or swirl layer, using iron pentacarbonyl as precursor and oxygen as oxidizing agent. With the CVD method metallic effect pigments with high color saturation can be produced even with low iron oxide layer thicknesses in the range from 20 to 35 nm. These metallic effect pigments are sold commercially, for example, as Paliocrom® 2850 (Orange) and Paliocrom® 2050 (Gold). A disadvantage of the CVD coating by the fluidized bed method is the need for complete fluidization (mobility) of the target substrates in the gas phase. Absent complete fluidization, agglomerates are generated during the coating process. The agglomerates generated impair the hiding power and narrow the useful particle size fraction, hence ultimately reducing the yield.

The use of thin aluminum flakes, produced by means of PVD, in the method described above is not possible industrially, owing to the pronounced agglomeration propensity and the enormous sensitivity to shear. The extremely thin, almost perfectly smooth aluminum flakes cannot be fluidized completely, or can be fluidized completely only with great difficulty, in the fluidized bed. For this reason, the substrates used industrially for metal oxide coating by the CVD process are exclusively aluminum flakes produced by wet milling. As already mentioned above, aluminum flakes from wet milling are significantly thicker, as an inherent result of the process, by comparison with thin aluminum flakes produced by PVD. Accordingly, DE 42 23 384 A1 specifies pigments having thicknesses in a range from about 100 to 200 nm, which are comparatively simple and inexpensive to produce by wet milling. To date there has been no description of fluidized-bed CVD coating on the basis of thin aluminum flakes produced by PVD.

One possibility for coating thin aluminum flakes produced by PVD with high-(refractive) index metal oxides is described in WO 2015/014484 A1. Here, thin aluminum flakes are used at a thickness in the range from preferably 5 to 30 nm. The pigment is coated not in a fluidized bed, but instead by hydrolysis of salt solutions. The overall structure obtained is a three-layer structure, comprising a layer of a high-index metal oxide, a low-index interlayer, of SiO₂, for example, and an outer layer composed of a low-index material. In WO 2009/083176 A1 as well, which describes the production of printing inks, there is mention of the possible use of thin aluminum flakes produced by PVD, as well as pigments obtained by milling with a ball mill. The high-index metal oxide layer in this case is applied by hydrolysis in water, requiring a phosphorus-containing additive as well.

Application of the metal oxide layer in aqueous solvents has numerous disadvantages, as also described in EP 0 033 457 A2. The pH necessary for precipitation is situated in a range in which there may be a reaction of aluminum with water. The reaction is critical particularly in the case of thin aluminum flakes, because of the increasing specific surface area. Since the pigments are attacked, the reproducibility of the reaction is poor. It is necessary, accordingly, to use dilute solutions. A number of workup steps are necessary as well.

As described in WO 2005/049739 A2, the application of a high-index metal oxide layer by wet-chemical oxidation in organic solvents is also possible, but the water content in the solvent is still 3 to 60 wt %. Moreover, a mixed layer is formed between the substrate and the high-index metal oxide layer. WO 2013/175339 A1 and EP 0 033 457 A2 describe alternative methods, in which the coating is carried out in a fluidized bed reactor, so making the process water-free. As mentioned above, however, a disadvantage arising in this case is that thin aluminum flakes produced by PVD cannot be used for a CVD coating of this kind, on account of their strongly pronounced agglomeration propensity during drying, a result in turn of their combination of high specific surface area with low surface roughness. These flakes, therefore, can be fluidized only with very poor reproducibility.

It is an object of the present invention, therefore, to provide a method for producing high-hiding metallic effect pigments on the basis of thin aluminum flakes with metal oxide coating, which overcomes the disadvantages described above, known in the prior art, in the coating of thin aluminum flakes, as they arise, for instance, in the CVD-based fluidized bed method or in wet-chemical precipitation processes.

This object is achieved by the embodiments of the present invention that are characterized in the claims.

In particular, the present invention provides a method for producing metallic effect pigments on the basis of aluminum flakes furnished with a metal oxide coating,
wherein the aluminum flakes have a thickness of 5 to 90 nm and are enveloped by the metal oxide coating,
wherein the metal oxide coating is composed of one or more metal oxides in a thickness of 5 to 150 nm and has a refractive index of at least 1.9,
wherein no further coating enveloping the aluminum flakes is provided between the surface of the aluminum flakes and the metal oxide coating,
comprising the steps of:
(a) Introducing the aluminum flakes in an organic solvent, with formation of a corresponding dispersion, and adding at least one metal oxide precursor compound, with dissolution of the metal oxide precursor compound, and
(b) Decomposing the metal oxide precursor compound in the organic solvent, to form the metal oxide coating on the aluminum flakes.

The method of the invention allows the provision of high-hiding metallic effect pigments on the basis of thin aluminum flakes with metal oxide coating, where the coating of the aluminum flakes, in accordance with the present invention, takes place in an organic solvent. The comparatively simple and inexpensive coating method allows savings to be made in time and costs, and at the same time the disadvantages known from the fluidized bed method and from wet-chemical precipitation processes are overcome. In particular there is no agglomeration of the thin aluminum flakes. Nor are they attacked by the solvent. In light of the low thickness of the aluminum flakes used, a significantly higher hiding power can be achieved, relative to comparable competitor products from the prior art, since a greater area can be covered for a given mass of pigment deployed. Accordingly, the metallic effect pigments obtainable with the method of the invention are hiding at a pigmentation of just 3% to 4% in the varnish system. The metallic effect pigments of the invention are suitable for a multiplicity of applications, such as for printing inks, especially as part of digital printing processes (inkjet), coating systems or cosmetics, where they can be used directly in the form of a paste.

In the text below, the method for producing metallic effect pigments on the basis of coated aluminum flakes in accordance with the present invention is described in more detail.

In step (a) of the method of the invention, the aluminum flakes are introduced in an organic solvent, with formation of a corresponding dispersion. Additionally in step (a) at least one metal oxide precursor compound is added, with dissolution of the metal oxide precursor compound. The sequence of the introducing of the aluminum flakes and the adding of the at least one metal oxide precursor compound here is not significant—that is, the aluminum flakes may also be introduced after the at least one metal oxide precursor compound has been added.

The aluminum flakes introduced in step (a) may be passivated, i.e., may have a covering of a native oxide layer. The thickness of this oxide layer is typically 3 to 5 nm and for the purposes of the present invention it is included in the thickness of the aluminum flakes as specified hereinafter.

In accordance with the present invention the aluminum flakes have a thickness in the range from 5 to 90 nm, preferably in the range from 5 to 50 nm and more preferably still in the range from 5 to 30 nm. The use of thin aluminum flakes allows a particularly high hiding power to be achieved. The thickness of the aluminum flakes is the average thickness, understood as the numerical average of all the measured thicknesses. The average thickness, also referred to as mean thickness, is determined by measurement on the basis of transmission electron microscopy (TEM) images. The mean thickness here is the mean value of at least 200 measurements on different aluminum flakes.

The aluminum flakes which are produced in step (a) typically have a thickness fluctuation (Δh) of at most 30%. The thickness fluctuation is preferably at most 25%, for example at most 20%, more preferably at most 15% and more preferably still at most 10%. The thickness fluctuation is obtained from the breadth of the thickness distribution, which is also referred to as thickness SPAN (t_{SPAN}). The thickness SPAN is calculated according to the formula below:

$${t}_{SPAN} = \frac{{t}_{90} - {t}_{10}}{{t}_{50}}$$

The indices in the formula above denote the respective value in the cumulative distribution curve. Accordingly, t₁₀ means that 10% of the aluminum flakes are thinner than the t₁₀ thickness value, while 90% of the aluminum flakes have a thickness greater than or equal to the t₁₀ thickness value.

From the thickness SPAN, the thickness fluctuation is obtained, finally, as a percentage figure:

Δh=t_{SPAN}×100%

In one preferred embodiment of the present invention the aluminum flakes are vacuum-metallized pigments (VMPs). In this case, then, they are thin aluminum flakes from physical vapor deposition which exhibit an extremely low thickness fluctuation and hence are much smoother than aluminum flakes from wet milling. Metallic effect pigments based on VMPs not only have a high hiding power but are also excellent in terms of the other coloristic data. VMPs are available commercially from various suppliers (Decomet® from Schlenk Metallic Pigments GmbH, METALURE® from Eckart GmbH, Metasheen® from BASF SE).

As far as the size of the aluminum flakes is concerned, there is no further limitation on the present invention. The size of the aluminum flakes is typically indicated as d₅₀. As already mentioned, the d₅₀ indicates the mean size of the aluminum flakes at which 50% of the aluminum flakes are smaller than the specified value. The d₅₀ is preferably 1 to 100 μm, for example 1 to 50 μm, 1 to 25 μm, 1 to 10 μm or 1 to 3 μm, though is not restricted to these. The d₅₀ is determined by measurement on the basis of laser scattering.

The ratio between the size of the aluminum flakes and their thickness, also referred to as the aspect ratio, is likewise not presently subject to any further restriction. It may be situated in a range from 50 to 5000, 100 to 2000 or 200 to 1000, though without being restricted to these.

Even before step (a) the aluminum flakes may be present in dispersed form. To this end an organic solvent is used which is identical or different, preferably different, from the organic solvent used in step (a), as described below. Without being restricted thereto, the aluminum flakes may be present before step (a) as a dispersion in isopropanol. This solvent has no substantial influence on the coating operation in step (b).

The aluminum flakes, which may already be present in dispersed form, are introduced in an organic solvent in step (a) of the method of the invention. When selecting the organic solvent in step (a), it must be ensured that the at least one metal oxide precursor compound which must also be added has sufficient solubility in the organic solvent in question. Furthermore, the boiling temperature of the organic solvent used ought to be higher than the temperature which in the organic solvent in question is necessary for the decomposition of the at least one metal oxide precursor compound in step (b).

As the organic solvent in step (a) it is possible for example to use one selected from the group consisting of 1-methoxy-2-propanol, 2-isopropoxyethanol, ethylene glycol monoethyl ether, ethylene glycol monopropyl ether, triethylene glycol, tetraethylene glycol, polyethylene glycol 400, propylene carbonate, N,N-dimethylacetamide and dimethyl sulfoxide, or mixtures thereof. Having proven advantageous in this context in particular is 1-methoxy-2-propanol, which is also referred to only as methoxypropanol. 1-Methoxy-2-propanol has sufficient solubility and also a comparatively high boiling temperature.

The organic solvent may include a small fraction of water, and in accordance with the present invention it is preferable for the water fraction to be not more than one part by mass, based on 100 parts by mass of the organic solvent.

Dispersing of the aluminum flakes introduced in the organic solvent may be achieved by mechanical action, such as by stirring, for example. Corresponding measures are known to a skilled person.

In step (a) of the method of the invention, furthermore, at least one metal oxide precursor compound is added, with dissolution of the metal oxide precursor compound. As mentioned, the adding of the at least one metal oxide precursor compound may also take place first, i.e., before the introducing of the aluminum flakes.

The at least one metal oxide precursor compound added in step (a) serves as a precursor for the metal oxide coating formed in step (b), with decomposition of the metal oxide precursor compound, said coating being a high-index coating composed of one or more metal oxides. Correspondingly the metal oxide precursor compound in question contains the respective metal of the metal oxide coating to be formed. As already mentioned above, the solubility thereof in the organic solvent used must be sufficient.

A high-index coating in the context of the present invention refers to a metal oxide coating which has a refractive index of at least 1.9.

In one preferred embodiment of the present invention the metal atom of the at least one metal oxide precursor compound is iron, copper or zinc. The metal oxide coating may be composed, for example, of Fe₂O₃, CuO, ZnO, or mixtures thereof. These metal oxides share the feature that they are high-index. Possible metal oxide precursor compounds contemplated in this context include the respective nitrates, acetates, acetylacetonates, malonates, alkoxides, oxalates and oximates of iron, copper or zinc, but without being restricted to these. In contrast to the corresponding halides, oxohalides and pseudohalides, these compounds have the advantage that they can be decomposed at a comparatively low temperature in step (b) to form the metal oxide coating. Furthermore, the respective nitrates, acetates, acetylacetonates, malonates, alkoxides, oxalates and oximates of iron, copper or zinc may have increased solubility in the relevant organic solvent, by comparison with the corresponding halides, oxohalides and pseudohalides.

In general the metal atom of the at least one metal oxide precursor compound may be present in complexed form, in the form, for instance, of a urea complex or urea derivative complex, but without being restricted to these.

If an Fe₂O₃ coating is to be formed in step (b), the metal oxide precursor compound used may be, for example, [Fe(H₂N(CO)NH₂)₆](NO₃)₃. If a CuO coating is to be formed in step (b), the metal oxide precursor compound used may be, for example, [Cu(H₂N(CO)NH₂)₄](NO₃)₂. If a ZnO coating is to be formed in step (b), the metal oxide precursor compound used may be, for example, [Zn(H₂N(CO)NH₂)₄](NO₃)₂ or [Zn(H₂N(CO)NH₂)₄(H₂₀)₂](NO₃)₂. In all of these cases the metal atom is complexed by plural urea molecules (urea ligands) and also, optionally, water molecules (aqua ligands).

The preparation of the relevant metal oxide precursor compounds is known to a skilled person. Thus the complexes [Fe(H₂N(CO)NH₂)₆](NO₃)₃ and [Cu(H₂N(CO)NH₂)₄](NO₃)₂ can be prepared, for example, by reaction of the corresponding nitrate salts Fe(NO₃)₃□(H₂O)₉ and Cu(NO₃)₂□(H₂O)₃ with urea. In a similar way this is also true of the complex [Zn(H₂N(CO)NH₂)₄](NO₃)₂ or [Zn(H₂N(CO)NH₂)₄(H₂O)₂](NO₃)₂.

In lieu of a single metal oxide precursor compound it is also possible to add two or more different metal oxide precursor compounds in step (a). By this means it is possible to achieve the formation of a mixed metal oxide layer in step (b). Also conceivable in principle is the formation of alternate or alternating layers. In accordance with the present invention, however, it is preferred for only one metal oxide precursor compound to be added in step (a), since by this means the refractive index and hence also the color of the metallic effect pigments can be controlled more effectively.

The color of the metallic effect pigments is determined critically by not only the refractive index but also the thickness of the metal oxide coating. The thickness of the metal oxide coating can be adjusted via the added amount of the relevant metal oxide precursor compound in step (a). For a given quantity of aluminum flakes introduced, the thickness of the metal oxide coating increases, of course, as the amount of the relevant metal oxide precursor compound added goes up. The amount of the metal oxide precursor compound added is adjusted here such that step (b) produces a metal oxide coating having a thickness of 5 to 150 nm, for example 10 to 100 nm or 20 to 75 nm.

In step (b) of the method of the invention the metal oxide precursor compound is decomposed in the organic solvent, to form the metal oxide coating on the aluminum flakes.

To achieve decomposition of the relevant metal oxide precursor compound, the dispersion of the aluminum flakes with the added metal oxide precursor compound in the organic solvent is heated to the temperature necessary for this to occur. The decomposition, accordingly, is a thermal decomposition. As mentioned above, the boiling temperature of the organic solvent ought to be higher than the temperature which is needed in the relevant organic solvent for the decomposition of the at least one metal oxide precursor compound. As a consequence of the thermal decomposition, the respective metal oxide is deposited on the aluminum flakes, which optionally are passivated. A metal oxide coating enveloping the aluminum flakes is consequently formed. This coating may initially still contain residual organic matter originating from the relevant metal oxide precursor compound.

After step (b) the resulting metallic effect pigments are in the form of a paste, which either may be used directly for the corresponding purpose or may be adapted for diverse purposes by replacing or changing the solvent, without drying. An alternative option, however, is to carry out spray drying, where the metallic effect pigments are not to be used directly and instead are to be stored in solid form. Calcining, in diphenyl ether, for instance, is a further option. By this means the residual organic matter originating from the relevant metal oxide precursor compound is decomposed.

In accordance with the present invention there is no further coating enveloping the aluminum flakes between the surface of the aluminum flakes and the metal oxide coating which envelops them and which is composed of one or more metal oxides in a thickness of 5 to 150 nm and has a refractive index of at least 1.9.

As and when required, however, an optional layer may be formed on the metal oxide coating. When present, this layer functions as an outer protective layer and necessarily has a refractive index of less than 1.8. The optional layer may be composed of SiO₂, for example. Also possible is the modification of the metal oxide coating or of the outer protective layer optionally formed thereon with silanes.

In a further aspect, the present invention relates to metallic effect pigments on the basis of aluminum flakes furnished with a metal oxide coating, which are obtainable by the method of the invention described above,
wherein the aluminum flakes have a thickness of 5 to 90 nm and are enveloped by the metal oxide coating,
wherein the metal oxide coating is composed of one or more metal oxides in a thickness of 5 to 150 nm and has a refractive index of at least 1.9, and
wherein no further coating enveloping the aluminum flakes is provided between the surface of the aluminum flakes and the metal oxide coating.

The metallic effect pigments of the invention are subject analogously to the statements above in relation to the method of the invention for producing metallic effect pigments.

The metallic effect pigments of the invention have a color difference dE110° of less than 1.5 at a pigmentation of 3%. At a pigmentation of 4%, the metallic effect pigments of the invention may even have a color difference dE110° of less than 1.0. The color difference dE110°, which is a measure of the hiding power of the metallic effect pigments, is measured in agreement with the DIN 55987 standard.

Lastly the present invention relates to the use of the metallic effect pigments of the invention for printing inks, inkjet applications, coating systems, mass colorations of plastic, or cosmetics. As mentioned above, the metallic effect pigments of the invention, which are characterized by a high hiding power, may in many cases be used directly in the form of a paste, without being dried beforehand. For digital printing processes (inkjet) in particular, the metallic effect pigments of the invention have proven particularly advantageous.

The present invention allows the provision of high-hiding metallic effect pigments on the basis of thin aluminum flakes with metal oxide coating which can be produced in a simple and inexpensive way. The present invention in particular overcomes the disadvantages known in the prior art for the coating of thin aluminum flakes, as they occur, for instance, in the CVD-based fluidized bed process or in wet-chemical precipitation processes.

### DESCRIPTION OF THE FIGURES

FIG. 1 shows a plot of the color difference dE110° as a function of the pigmentation (in %) for metallic effect pigments of the invention and also for metallic effect pigments from the prior art.

### EXAMPLES

The examples below serve for further elucidation of the present invention, though without being restricted to these.

### Example 1

### Powder of Aluminum Flakes Furnished with Fe₂O₃ Coating

Synthesis of the Metal Oxide Precursor Compound [Fe(H₂N(CO)NH₂)₆](NO₃)₃:

30.062 g (0.5005 mol) of urea were dissolved in 700 ml of ethanol with gentle heating (40° C.). Subsequently a solution of 31.11 g (0.077 mol) of Fe(NO₃)₃□(H₂O)₉ in 175 ml of ethanol was added. The solution was stirred for two hours, at which point the solid [Fe(H₂N(CO)NH₂)₆](NO₃)₃ formed was isolated by filtration, washed with ethanol and dried for twelve hours in a drying cabinet at 50° C. The yield was 33.8 g (73%).

Coating of Thin Aluminum Flakes by Thermal Decomposition of [Fe(H₂N(CO)NH₂)₆](NO₃)₃ in Solution:

11 g of a dispersion of aluminum flakes in isopropanol, containing 1.1 g of aluminum flakes (VMPs, Decomet® from Schlenk Metallic Pigments GmbH) having a thickness of 25 nm and a d₅₀ of 21 μm, were dispersed in 1 l of 1-methoxy-2-propanol. 10 g of [Fe(H₂N(CO)NH₂)₆](NO₃)₃ were dissolved therein and the dispersion was heated at boiling (120° C.) under reflux for two hours.

In two further steps, in each case after cooling, 10 g portions of [Fe(H₂N(CO)NH₂)₆](NO₃)₃ were subsequently added and the dispersion was heated at boiling under reflux for two hours each time. A total of 30 g of the metal oxide precursor compound were therefore used.

After cooling, the sample thus obtained was filtered and the solid product was washed with isopropanol and dispersed in isopropanol without being dried. The suspension was subsequently spray-dried, to give, lastly, a gold-colored powder.

### Example 2

### Suspension of Aluminum Flakes Furnished with Fe₂O₃ Coating

Synthesis of Metal Oxide Precursor Compound [Fe(H₂N(CO)NH₂)₆](NO₃)₃:

The synthesis took place in the same way as for Example 1.

Coating of Thin Aluminum Flakes by Thermal Decomposition of [Fe(H₂N(CO)NH₂)₆](NO₃)₃ in Solution:

1 g of a dispersion of aluminum flakes in isopropanol, containing 0.24 g of aluminum flakes (VMPs, Decomet® from Schlenk Metallic Pigments GmbH) having a thickness of 25 nm and a d₅₀ of 21 μm, was dispersed in 100 ml of 1-methoxy-2-propanol and 0.5 ml of water. 0.5 g of [Fe(H₂N(CO)NH₂)₆](NO₃)₃ was dissolved therein and the dispersion was heated at boiling (120° C.) under reflux for two hours. After it had cooled, a further 0.5 g of [Fe(H₂N(CO)NH₂)₆](NO₃)₃ was added and the dispersion was again heated at boiling under reflux for two hours.

After the dispersion had cooled, the solvent was slowly removed by filtration, avoiding complete drying-up of the sample obtained in the meantime. This sample was then dispersed in 100 ml of fresh 1-methoxy-2-propanol and 0.5 ml of water. Again 0.5 g of [Fe(H₂N(CO)NH₂)₆](NO₃)₃ was added and the dispersion was heated at boiling under reflux for two hours. After the dispersion had cooled, finally, a further 0.5 g of [Fe(H₂N(CO)NH₂)₆](NO₃)₃ was added and the dispersion was again heated at boiling under reflux for two hours.

The above step was repeated as a whole once, and so a total of 3.0 g of the metal oxide precursor compound were used.

After cooling, the sample thus obtained was filtered and the solid product was washed with isopropanol and ethyl acetate and redispersed in ethyl acetate without being dried, to give, finally, a gold-colored suspension.

### Example 3

### Powder of Aluminum Flakes Furnished with CuO Coating

Synthesis of the Metal Oxide Precursor Compound [Cu(H₂N(CO)NH₂)₄](NO₃)₂:

2.7 g (0.045 mol) of urea were dissolved in 100 ml of butanol with gentle heating (40° C.). After the solution had cooled to room temperature, 2.42 g (0.01 mol) of Cu(NO₃)₂□(H₂O)₃ were added. The solution was stirred for two hours, at which point the solid [Cu(H₂N(CO)NH₂)₄](NO₃)₂ formed was isolated by filtration, washed with butanol and acetone and dried for 16 hours in a drying cabinet at 50° C. The yield was 3.176 g (74.3%).

Coating of Thin Aluminum Flakes by Thermal Decomposition of [Cu(H₂N(CO)NH₂)₄](NO₃)₂ in Solution:

1 g of a dispersion of aluminum flakes in isopropanol, containing 0.24 g of aluminum flakes (VMPs Decomet® from Schlenk Metallic Pigments GmbH) having a thickness of 25 nm and a d₅₀ of 21 μm, was dispersed in 100 ml of 1-methoxy-2-propanol. Different amounts of [Cu(H₂N(CO)NH₂)₄](NO₃)₂ were dissolved therein in a plurality of steps, and in each step the dispersion was heated at boiling (120° C.) under reflux for two hours.

In the first two steps portions of 0.2 g [Cu(H₂N(CO)NH₂)₄](NO₃)₂ were added, whereas in the two following steps portions of 0.3 g of [Cu(H₂N(CO)NH₂)₄](NO₃)₂ were added. At that point the sample obtained in the meantime was slowly isolated by filtration, without drying up in the process, and was redispersed in 100 ml of 1-methoxy-2-propanol. Then, in two further steps, portions of 0.5 g of [Cu(H₂N(CO)NH₂)₄](NO₃)₂ were added.

Once again the sample obtained in the meantime was isolated by filtration, without drying up in the process, and was again redispersed in 100 ml of 1-methoxy-2-propanol. In two further steps, portions of 0.5 g of [Cu(H₂N(CO)NH₂)₄](NO₃)₂ were added. In total, therefore, 3.0 g of the metal oxide precursor compound were used.

The sample thus obtained was subsequently isolated by filtration, without drying up in the process, and was dispersed in 50 ml of diphenyl ether and heated at boiling (258° C.) for five minutes. After cooling, the sample was isolated by filtration, washed with ethanol, acetone and diethyl ether, and dried for 16 hours at 50° C., to give, finally, a pale gold-colored powder.

### Investigation of the Coloristic Data

The metallic effect pigments from Examples 1 to 3 were investigated in more detail for their coloristic data and subjected to comparison with metallic effect pigments from the prior art.

The coloristic data were determined by measurement on corresponding drawdown cards. To this end, knife-coated drawdowns of the respective metallic effect pigments with different pigmentation in a solventborne nitrocellulose/polycyclohexanone/polyacrylic varnish with a solids fraction of 10% were produced on a black-white DIN A5 card from TQC using a 38 μm wire doctor on an automatic film-drawing device from Zehntner. The pigmentation here refers in each case to the pigment fraction in the total varnish mixture. All of the percentages here should be understood as wt %.

Aside from the 60° gloss measurement, the coloristic data were measured using the Byk-mac i instrument from Byk. To determine the hiding power, expressed by the color difference dE110°, the coloristic data were measured on the white and black side of the DIN A5 card. The 60° gloss measurement took place using the Byk micro-TRI-gloss instrument from Byk. The results are collated in Table 1 below:

TABLE 1

| | | Pigmentation | Gloss | huv | | | | |
|---|---|---|---|---|---|---|---|---|
| Example | Workup | (in %) | 60° | 15*S | dE15° | dE110° | dE45° | AL |
| Example 1 | dried | 1 | 75.9 | 69.6 | 3.6 | 38.4 | 20.4 | 23.5 |
| | (powder) | 2 | 61.4 | 69.8 | 0.6 | 11.5 | 4.1 | 23.2 |
| | | 3 | 52.5 | 69.8 | 0.2 | 1.3 | 0.3 | 23.6 |
| | | 4 | 51.6 | 69.9 | 0.2 | 0.2 | 0.4 | 23.9 |
| Example 2 | undried | 3 | 101.0 | 70.9 | 1.6 | 1.1 | 0.2 | 32.3 |
| | (suspension) | | | | | | | |
| Example 3 | dried | 3 | 47.9 | 65.1 | 0.2 | 1.4 | 0.2 | 18.2 |
| | (powder) | 4 | 36.8 | 64.3 | 0.5 | 0.4 | 0.3 | 16.1 |

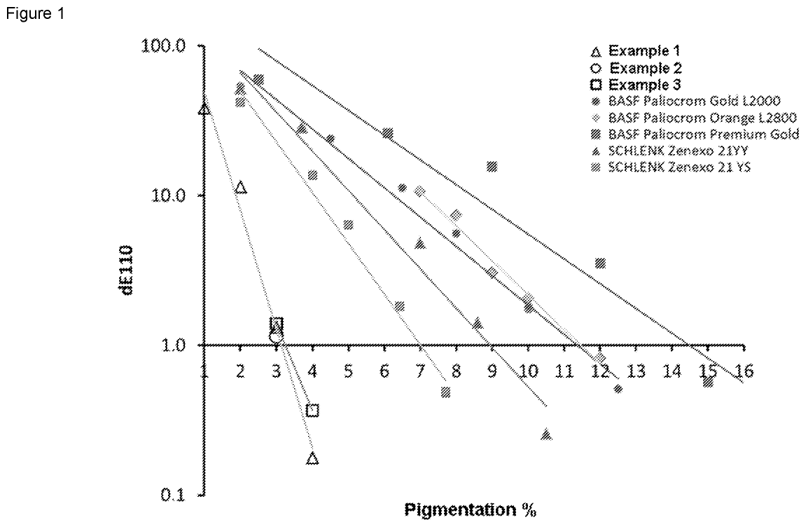

The values contained in Table 1 for the color difference dE110° of the metallic effect pigments of the invention from Examples 1 to 3 are plotted in FIG. 1 as a function of the pigmentation (in %). FIG. 1 also shows the values for the color difference dE110° of metallic effect pigments from the prior art, determined by the same measurement method. As is clear from a comparison of the values, the metallic effect pigments of the invention have a significantly higher hiding power, as manifested in a lower value for the color difference dE110°. Thus at a pigmentation of just 3%, a color difference dE110° of less than 1.5 is obtained. At a pigmentation of 4%, indeed, the color difference dE110° is significantly less than 1.0. In the case of the metallic effect pigments from the prior art, conversely, the pigmentation needed to achieve this is about twice as great.

1. A method for producing metallic effect pigments on the basis of aluminum flakes furnished with a metal oxide coating,
wherein the aluminum flakes have a thickness of 5 to 90 nm and are enveloped by the metal oxide coating,
wherein the metal oxide coating is composed of one or more metal oxides in a thickness of 5 to 150 nm and has a refractive index of at least 1.9,
wherein no further coating enveloping the aluminum flakes is provided between the surface of the aluminum flakes and the metal oxide coating,
comprising the steps of:
(a) Introducing the aluminum flakes in an organic solvent, with formation of a corresponding dispersion, and adding at least one metal oxide precursor compound, with dissolution of the metal oxide precursor compound, and
(b) Decomposing the metal oxide precursor compound in the organic solvent, to form the metal oxide coating on the aluminum flakes.

2. The method as claimed in claim 1, wherein the aluminum flakes have a thickness fluctuation (Δh) of at most 30%.

3. The method as claimed in claim 1 or 2, wherein the aluminum flakes are vacuum-metallized pigments.

4. The method as claimed in any of claims 1 to 3, wherein the organic solvent is selected from the group consisting of 1-methoxy-2-propanol, 2-isopropoxyethanol, ethylene glycol monoethyl ether, ethylene glycol monopropyl ether, triethylene glycol, tetraethylene glycol, polyethylene glycol 400, propylene carbonate, N,N-dimethylacetamide and dimethyl sulfoxide, or mixtures thereof.

5. The method as claimed in claim 4, wherein the organic solvent is 1-methoxy-2-propanol.

6. The method as claimed in any of claims 1 to 5, wherein the aluminum flakes even before step (a) are present in dispersed form and to that end an organic solvent is used which is identical or different, preferably different, from the organic solvent used in step (a).

7. The method as claimed in claim 6, wherein the aluminum flakes before step (a) are present as a dispersion in isopropanol.

8. The method as claimed in any of claims 1 to 7, wherein the metal oxide coating is composed of Fe₂O₃, CuO, ZnO, or mixtures thereof.

9. The method as claimed in claim 8, wherein the at least one metal oxide precursor compound is selected from the group consisting of nitrates, acetates, acetylacetonates, malonates, alkoxides, oxalates and oximates of iron, copper or zinc.

10. The method as claimed in claim 9, wherein the metal atom of the at least one metal oxide precursor compound is present in complexed form.

11. The method as claimed in claim 10, wherein the complexed form is a urea complex or urea derivative complex.

12. The method as claimed in any of claims 8 to 11, wherein the at least one metal oxide precursor compound is selected from the group consisting of [Fe(H₂N(CO)NH₂)₆](NO₃)₃, [Cu(H₂N(CO)NH₂)₄](NO₃)₂ and [Zn(H₂N(CO)NH₂)₄](NO₃)₂.

13. A metallic effect pigment on the basis of aluminum flakes furnished with a metal oxide coating, obtainable by the method as claimed in any of claims 1 to 12,
wherein the aluminum flakes have a thickness of 5 to 90 nm and are enveloped by the metal oxide coating,
wherein the metal oxide coating is composed of one or more metal oxides in a thickness of 5 to 150 nm and has a refractive index of at least 1.9, and
wherein no further coating enveloping the aluminum flakes is provided between the surface of the aluminum flakes and the metal oxide coating.

14. The metallic effect pigment as claimed in claim 13, wherein the metallic effect pigment has a color difference dE110° of less than 1.5 at a pigmentation of 3%.

15. The use of the metallic effect pigment as claimed in claim 13 or 14 for printing inks, inkjet applications, coating systems, mass colorations of plastic, or cosmetics.
